(19) United States
(12) Patent Application Publication
(10) Pub. No.: US 2013/0185770 A1
(43) Pub. Date: Jul. 18, 2013

(54) METHODS AND SYSTEMS FOR PROVIDING ACCESS TO AN ONLINE SYSTEM

(71) Applicant: SALESFORCE.COM, INC., San Francisco, CA (US)

(72) Inventor: Dipak Patil, Miraj (Sangli District) (IN)

(73) Assignee: SALESFORCE.COM, INC., San Francisco, CA (US)

(21) Appl. No.: 13/729,023

(22) Filed: Dec. 28, 2012

(30) Foreign Application Priority Data
Jan. 12, 2012 (IN) 134/CHE/2012

(51) Int. Cl. H04L 29/06

(52) U.S. Cl. CPC H04L 63/08
USPC 726/4

(57) ABSTRACT

Methods and systems are provided for enabling access to a secure system from a remote system without directly logging into the secure system for debugging purposes. The secure system and the remote system may login to a host system with a session ID and establish a session. The secure system starts a Hyper Text Transport Protocol (HTTP) enabled debugger to enable debugging of the web browser traffic. The HTTP enabled debugger may be displayed on the remote system via the host system. The remote system may enter debug commands from a web browser on the remote system. The debug commands are then applied on the web browser of the secure system.

### CROSS REFERENCE TO RELATED APPLICATIONS

The following commonly owned, co-pending United States Patents and Patent Applications, including the present application, are related to each other. Each of the other patents/applications are incorporated by reference herein in its entirety:

Indian Application No. 134/CHE/2012 entitled “METHODS AND SYSTEMS FOR PROVIDING ACCESS TO AN ONLINE SYSTEM” By Dipak Patil, filed Jan. 12, 2012 Attorney Docket No. 48-77/762IN1.

U.S. patent application Ser. No. ______ entitled “METHODS AND SYSTEMS FOR PROVIDING ACCESS TO AN ONLINE SYSTEM” by Dipak Patil, filed Dec. ______, 2012 Attorney Docket No. 48-79/762US.

### CLAIM OF PRIORITY

This application claims the benefit of Indian Patent Application 134/CHE/2012, entitled “METHODS AND SYSTEMS FOR PROVIDING ACCESS TO AN ONLINE SYSTEM”, by Dipak Patil, filed Jan. 12, 2012 (Attorney Docket No. 48-77/762IN1), the entire contents of which are incorporated herein by reference.

### COPYRIGHT NOTICE

A portion of the disclosure of this patent document contains material which may be subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to providing access to a secure system from a remote system without directly logging into the secure system.

### BACKGROUND

The subject matter discussed in the background section may not be assumed to be prior art merely as a result of its mention in the background section. Similarly, a problem mentioned in the background section or associated with the subject matter of the background section may not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request.

Development tools may be provided for developers to develop applications, which may make use of the database. A customer of the developer may install the application, and run the application on the customer's system. There may be a bug or a glitch in the application that the developer may need to fix.

Unfortunately, conventional web based development tools require developers to login to a secure user system in order to access either the application or the data on the user system in order to debug the application. This specification recognizes that providing access to secure user systems to non-employees or product experts other than employees may compromise the security of the system and the corporation.

Accordingly, this specification recognizes that it may be desirable to provide techniques for providing access to developers to gain access to secure systems without logging in directly to the secure system.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 shows a block diagram of an embodiment of a web-based system of accessing data on a secure system from a remote system without directly accessing the secure system;

FIG. 2 shows a flow diagram of an embodiment of a host system side method of using web-based system of accessing data on a secure system from a remote system without directly accessing the secure system;

FIG. 3 shows a flow diagram of an embodiment of a secure system side method of using web-based system of accessing data on a secure system from a remote system without directly accessing the secure system;

FIG. 4 shows a flow diagram of an embodiment of a remote system side method of using web-based system of accessing data on a secure system from a remote system without directly accessing the secure system;

FIG. 5 shows a block diagram of an embodiment of an environment where in an on-demand database service might be used for methods and systems for web-based development tools;

FIG. 6 shows a block diagram of an embodiment of elements of FIG. 5 and various possible interconnections between elements in an embodiment for methods and systems for web-based development tools;

FIG. 7 illustrates an embodiment of an environment within which the system for web-based development tools may operate;

FIG. 8 illustrates embodiment of elements of FIG. 7 and various possible interconnections between elements of the environment.

### DETAILED DESCRIPTION

### General Overview

Systems and methods are provided for a remote system to access a secure system without directly logging into the secure system using web based tools. In an embodiment access across the network may be required for debugging a software application. In an embodiment, the software application may store data on an on-demand multi-tenant database network system.

As used herein, the term multi-tenant database system refers to those systems in which various elements of hardware and software of the database system may be shared by one or more tenants. For example, a given application server may simultaneously process requests for a great number of tenants, and a given database table may store rows for a potentially much greater number of tenants. As used herein, the term query plan refers to a set of steps used to access information in a database system.

Below, mechanisms and methods for providing access to secure systems across network without directly logging into the secure system, optionally in an on-demand multi-tenant database network system, are described with reference to example embodiments. In this specification user systems may refer to any system connected to the network having at least one or more processors, a memory system, an input/output system, and a network interface.

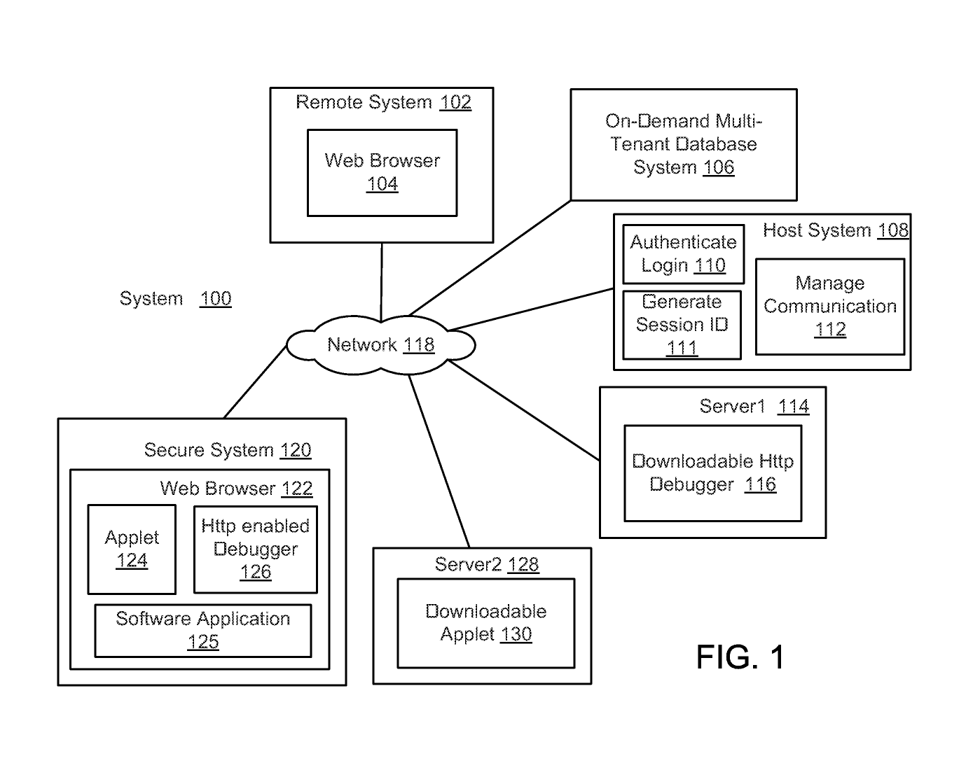

FIG. 1 shows an embodiment of system 100, a system for accessing a secure system from a remote system without directly accessing the secure system, which may optionally be used with an on-demand multi-tenant database system. In an embodiment, system 100 may include remote system 102, web browser 104, on-demand multi-tenant database system 106, host system 108, authenticate login 110, generate session ID 111, manage communication 112, server1 114, downloadable Hyper Text Transport Protocol (HTTP) enabled debugger, network 118, secure system 120, web browser 122, applet 124, software application 125, HTTP enabled debugger 126, server2 128, and downloadable applet 130 among others. In other embodiments, system 100 may not have all of the elements or features listed and/or may have other elements or features instead of or in addition to those listed.

In FIG. 1, end users of web software applications running on end user's system may encounter difficult to debug problems. Sometimes the problems cannot be reproduced on the web software application developer's machine. Without reproducing the problem, the developer may not be able to debug the problem. The end user may have a secure machine with privileged data and may not want to give direct access to the developer. The developer may have to debug binary files and log files and may require many iterations of debugging. If the problem is difficult and cannot be debugged with binary files and log files, the developer may have to be physically present at the end user's site in order to debug. If the developer is given remote access to the end user's data without directly logging into the end user's machine, the developer can debug the problem, thereby securing the privileged data on the end user's machine. A remote debugging facility may be provided through a HTTP enabled debugger and a host system. The end user and the developer can login to a host system on the internet with a shared session ID and establish a joint session between the user and developer. The end user and/or the remote developer may also be given a separate login session ID, which establishes a session for the end user and/or remote developer on the host system. Alternatively, the shared session ID may be used as the login session ID also. The end user may start the web software application and the HTTP enabled debugger. The developer can see the data being applied on the web software application through the HTTP enabled debugger on the web browser running on the developer's machine. The developer may enter debug commands on a web browser running on the developer's machine and apply the debug commands on the user's machine and debug the problem.

System 100 may be a system for providing access to secure systems from other systems across the network without directly logging into the secure system. In one example, system 100 may provide access from a remote system to secure systems, via a Hyper Text Transport Protocol (HTTP) enabled debugger without directly logging into the secure system while a host system establishes a session and manages the communication. A product expert on the developer system may login to the host system from the remote system for debugging software problems on a secure system across the network. In order to maintain the confidentiality of data and/or data security, the secure system may not provide direct access to the remote systems for debugging or any other reason such as maintenance. The secure system may indirectly provide access to the data by running a HTTP enabled debugger on the secure system and connecting to a host system to provide connectivity.

Remote system 102 may be a system at the developer's site. Remote system 102 may run machine instructions for running a web browser, and may include a memory storing machine instructions and a processor for implementing the machine instructions. Remote system 102 may receive requests from other remote systems (either directly or via a host system), compute a response (e.g., examine the received data and enter debug commands), and return the results to the other remote systems. Remote system 102 may be a system that is run by a developer, and the developer may user remote system 102 for debugging applications installed on the systems of customers.

Web browser 104 may be a HTTP client (or a client available via another protocol), which may include software applications for interacting with other devices on the network. Web browser 104 may request information from other machines available on the network, and may present the information requested to the user on remote system 102. Web browser 104 may be used by remote system 102 to access information provided by servers (e.g., host system) or files in a file system. Web browser 104 may be used by remote system 102 to access and debug software applications on end user's machine via third server (e.g., a host system).

On-demand multi-tenant database system 106 is optional, and may include a multi-tenant database for storing the tenant data, and a database server among other. On-demand multi-tenant database system 106 may have one or more machines on which the multi-tenant database and other applications run. On-demand multi-tenant database system 106 may receive requests from remote systems. Multi-tenant database may be a database system with multiple tenants that each has a degree of access to at least a portion of the database system that may or may not be the same as the degree of access as other tenants. Each tenant may be an individual or an organization, and each tenant may have representatives, members, employees, customers and/or other entities associated with the tenant, which in turn may also have different degrees of access to the tenant's portion of the database as a result of the tenant's tenancy of the multi-tenant database. The degree of access granted to those associated with the tenant and/or which entities (e.g., representatives, members, employees, customers and/or other entities) are associated with the tenant may be determined by the tenant. The database system may include multiple databases, and each database may be partitioned and/or otherwise shared amongst the multiple tenants. Multi-tenant database may have any number of tenants, may have any number of remote systems, and may access a portion of the database. The multitenant database may be provided on-demand in that the multi-tenant database may be provide to the tenant as a service so that he the tenant need to worry about the details of maintaining the a database system. In an embodiment the multitenant database may be a relational database. In an embodiment, on-demand multi-tenant database system 106 may store a downloadable applet and/or development for remote systems. The applet may start a HTTP enabled debugger. In another embodiment, on-demand multi-tenant database system 106 may store the downloadable the HTTP enabled debugger. In an embodiment, the software application being debugged may store data in on-demand multi-tenant database system 106. In an embodiment, the application developed by the developer may make use of on-demand multitenant database system 106 and may include functions calls to functions available as part of the Application Program Interface (API) of on-demand multitenant database system 106.

Host system 108 may be a user system that connects to other user systems, via a network. Host system 108 may be a device having at least one or more processors, a memory system, an input/output system, and a network interface, for example. Host system 108 may receive a request for generating a session ID, receive login, password, and session ID from user systems to authenticate login, establish a session by checking session ID, and manage communication among remote user systems.

In an embodiment, authenticate login 110 receives all of or some of the logins, passwords and session IDs from the user systems and authenticates the login information. In another embodiment, authenticate login 110 may receive other information to authenticate logins. Authenticate login 110 may establish a session with user systems logging with the same session ID. A session may be a series of interactions between two systems. During a session two user systems may share data.

Generate session ID 111 may generate a shared session ID upon a request from a user system. A shared session ID may be a unique identification string used to identify the user systems and may be sent to the user system requesting the shared session ID. The shared session ID may be shared with another user system in order to communicate via host system 108. The shared session ID may or may not be the same as the login session ID, established when opening a session between a user system and host system 108.

Manage communication 112 manages communication between the two user systems in session. After a session is established between user systems, manage communication 112 receives data from a first user system and sends the data to a second user system that participates in the same session as the first user system.

Server1 114 may be a device connected to the network storing a downloadable HTTP enabled debugger. Server1 114 may have at least one or more processors, a memory system, an input/output system, and a network interface.

Downloadable HTTP enabled debugger 116 may be the executable HTTP enabled debugger stored on server1 114. Downloadable HTTP enabled debugger 116 may be downloaded by any system with access to server1 114. In an embodiment, downloadable HTTP enabled debugger 116 may reside on server1 114. In another embodiment, downloadable HTTP enabled debugger may be stored in on-demand multi-tenant database system 106. The HTTP enabled debugger captures and debugs all outgoing and incoming communications in the web browser and/or that relate to a program that uses HTTP protocol. In an embodiment, the HTTP enabled debugger allows the captured communication to be analyzed. The HTTP enabled debugger may allow the examination of each HTTP transaction which may be required for debugging.

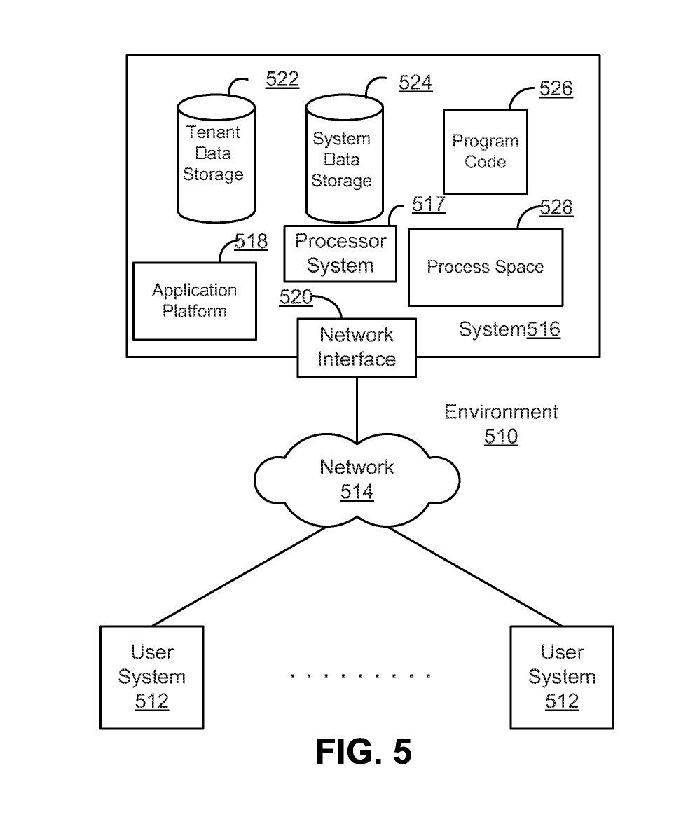

Network 118 (which also may be further discussed in conjunction with FIG. 5) may be any network or combination of networks of devices that communicate with one another, such as the Internet and/or one or more phone networks. Remote system 102 may interact with a secure system, via network 118, using a network interface (which may be also further discussed in conjunction with FIG. 5). Remote system 102, on demand multitenant database system 106, host system 108, server1 114, other servers, and/or systems may interact with one another via network 118.

Secure system 120 may be a system in which the user does not allow outsiders to login to. Secure system 120 may be the system of a customer of the developer upon which an application was installed that was written by the developer. Secure system 120 may connect to host system 108 and remote system 102, via network 118. Secure system 120 may be a device having at least one or more processors, a memory system, an input/output system, and a network interface, for example. Secure system 120 may send a request to host system 108 to establish a session with remote system 102, may send/receive data to remote system 102 via host system 108. Secure system 120 may be a secure system running software applications on confidential data.

Web browser 122 may be a HTTP client (or a client available via another protocol), which may include software applications for interacting with other devices on network 118. Web browser 122 may request information from other machines available on network 118, and may present the information requested to the user on secure system 120. Web browser 122 may be used by secure system 120 to send and receive data to and from (respectively) remote system 102. In an embodiment, web browser 104 and web browser 122 may be similar. In an embodiment, web browser 122 may be a Java enabled web browser so that an applet may download the HTTP enabled debugger and start the HTTP enabled debugger.

Applet 124 may be a program written in the Java programming language that may be embedded in a web page or HTML document. Applet 124 may reside on secure system 120 in Java enabled web browser 122 to download downloadable HTTP enabled debugger 116 on secure system 120 and start the HTTP enabled debugger. If web browser 122 is not Java enabled, secure system 120 may have to download downloadable HTTP enabled debugger 116 and start the HTTP enabled debugger manually. Applet 124 downloads the downloadable HTTP enabled debugger 116 from server1 114 and installs on secure system 120. HTTP enabled debugger 126 is the installed HTTP enabled debugger. The HTTP enabled debugger sends incoming and outgoing data on web browser 122 to remote system 102 for debugging. The HTTP enabled debugger may also receive debug commands from web browser 104 on remote system 102.

Server2 128 may be a server and/or other device connected to the network storing a downloadable applet. Server2 128 may be a device having one or more processors, a memory system, an input/output system, and a network interface. In an embodiment, downloadable applet 130 maybe an applet stored on server2 128. In another embodiment, downloadable applet 130 may reside on any server for example, on-demand multi-tenant database system 106 or server1 114. Downloadable applet 130 may be downloaded by web browser 122 (where the use of Java has been enabled) on secure system 120.

Thus, putting together the elements of FIG. 1, remote system 102 is used by a developer for developing an application that is installed on or runs of secure system 120. Secure system 120 installs the application and encounters a bug. Consequently, so that the developer can debug the application, secure system 120 down loads applet 124 from downloadable applet 130 on server2 128 and installs applet 124. Using applet 124, secure system 120 downloads and installs HTTP enabled debugger 124 from downloadable HTTP debugger 116 on server1 114. Remote system 102 and secure system 120 may establish a shared session on host 108. Software application 125 may be an application running on secure system which requires debugging. In an embodiment, software application 125 stores data on on-demand multi-tenant database system. During the shared session, secure system 120 runs software application 125 that needs debugging in HTTP enabled debugger 126 within web browser 122. Results of running software application 125 are sent to host system 108, which in turn sends the results to web browser 104 on remote system 102. As a part of the shared session at host 108, the developer may also send debug commands from remote system 102, through web browser 104, to host 108, which forwards the debug command to HTTP enabled debugger 126 on secure system 120, and HTTP debugger 126 implements the command. The result of implementing the command are relayed, via host 108 back to remote system 102, where the developer may decide to repeat the process and issue a subsequent debug command.

### Host-Side Method

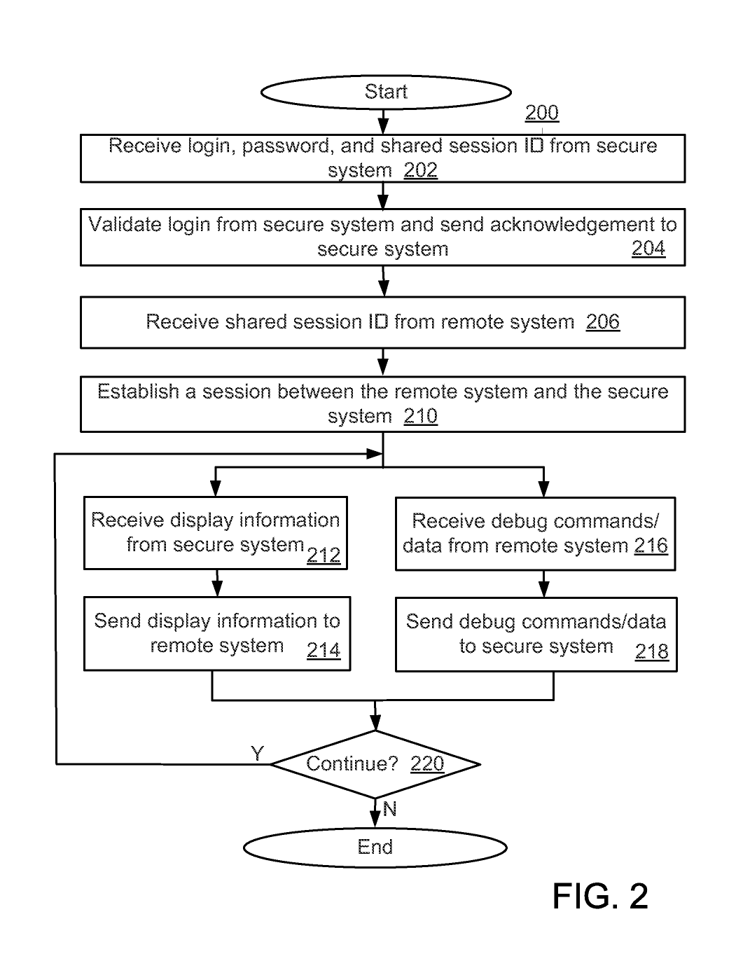

FIG. 2 shows a flowchart of an embodiment of a host system-side method 200 for of using a web based system for providing access from a remote system via a host system to a secure system without directly logging into the secure system. Secure system 120 and remote system 102 may login into host system 108 with a session ID and establish a session. Establishing a session may ensure secure transfer of data between secure system 120 and remote system 102. Host system 108 may facilitate communication between the secure system 120 and remote system 102.

In step 202, host system 108 may receive a login identifier, a password, and/or a shared session ID from secure system 120. In step 204, host system 108 validates the login, password, and/or shared session ID. In step 204, host system 108 may send an acknowledgement to secure system 120 about a successful login. In step 206, host system 108 receives the shared session ID from remote system 102. In step 210, host system 108 validates the shared session ID of remote system 102 and establishes a session between secure system 120 and remote system 102. A session may be established with systems logging in with the same session ID. Host system 108 facilitates the exchange of the data between secure system 120 and remote system 102. Host system 108 may communicate with secure system 120 and remote system 102 simultaneously or only one of secure system 120 and remote system 102.

In another embodiment, method 200 in step 202, host system 108 may receive a login, a password, and/or a shared session ID from remote system 102, in step 204, host system 108 may send an acknowledgement to remote system 102 about a successful login, in step 206, host system 108 may receive the shared session ID from secure system 120 and in step 210, host system 108 validates the shared session ID received from secure system 120 and establishes a session.

In step 212, host system 108 receives display information from secure system 120. The display information may include incoming and/or outgoing web traffic on the web browser and may be sent by HTTP enabled debugger 126 via web browser 122. The display information may be the result of running a software application that requires debugging by the developer or another expert. In an embodiment, the software application may retrieve data, store data, and/or otherwise interact with on-demand multi-tenant database system 106. In step 214, host system 108 sends the display information received in step 212 to remote system 102. The debug commands may have been sent in response to an earlier implementation of step 212. Similarly, the display information received from remote system 102 in step 212 may have been the result of debug command sent in an implementation of step 214 that occurred prior to the implementation of step 212. In step 216, host system 108 receives display from remote system 102. The display information may include debug commands and/or other data for the HTTP enabled debugger. In step 218, host system 108 sends the display information received in step 214 to secure system 120. In step 220, method 200 host system 108 waits to receive more data from either secure system 120 or remote system 102. When more data is received from secure system 120, steps 212 and 214 are repeated. When more data is received from remote system 102, steps 216 and 218 are repeated. If in step 220 either remote system 102 or secure system 220 ends the session, such as by logging out, method 220 terminates.

In an embodiment, each of the steps of method 200 may be a distinct step. In other embodiments, method 200 may not have all of the above steps and/or may have other steps in addition to or instead of those listed above. The steps of method 200 may be performed in another order. Subsets of the steps listed above as part of method 200 may be used to form their own method. In an embodiment, there could be multiple instances of method 200.

### Secure System-Side Method

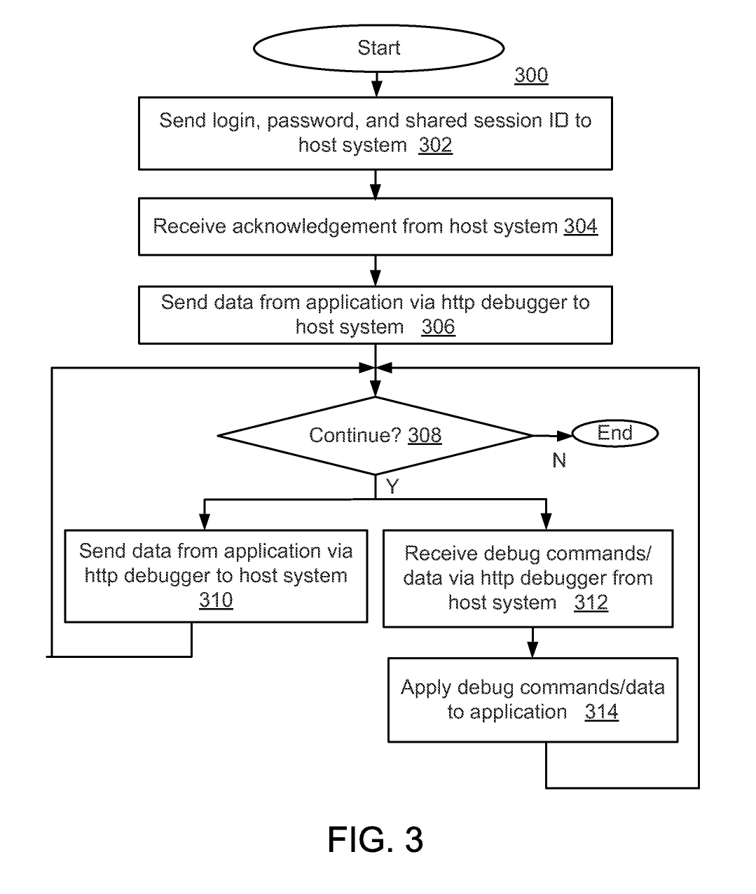

FIG. 3 shows a flowchart of an embodiment of a secure system-side method 300 of using a web-based system of providing access to a secure system from a remote system for debugging purposes.

In step 302, secure system 120 sends login identifier, password, and shared session ID to host system. The shared session ID may have been created earlier by remote system 102, or optionally by secure system 120, in scheduling the session at host 108. In another embodiment, after receiving the shared session ID (e.g., from remote system 102 or host 108) secure system 120 may send only a shared session ID to host system 108, without sending a login or password, and the shared session ID may also act as the login session ID. In step 304, secure system 120 receives an acknowledgement from host system 108. The acknowledgement may include information about the session established by host system 108 with remote system 102. In step 306, secure system 120 sends data from web browser 122 that requires debugging, via HTTP enabled debugger 126 to host system 108. The data may be the incoming and outgoing data to and from secure system 120 that results from running the software application that needs debugging on secure system 120.

In step 308, method 300 waits for further input from the user and/or for more data from host system 108. If secure system 120 receives input from the user to end the session or data from the host system 108 that the session has ended, method 300 proceeds to end method 300. Receiving data that the session has ended may result from the session timing out or from the developer ending the session. If method 300 does not end, then secure system may send to and/or receive data from host system 108. In step 310, secure system 120 sends more data from web browser 122 via HTTP enabled debugger to host system 108. The data sent in step 310 may result from implementing debug commands received from remote system 102 via host system 10. In step 312, secure system 120 receives debug commands and/or data from host system 108. The debug commands and/or data may be sent by remote system 102, via host system 108, in order to debug the software application running on secure system 120. In step 314, secure system 120 applies the debug commands on the software application, via HTTP enabled debugger 126. Step 314 may also include sending the results of applying the debug commands to remote system 102 via host system 108.

In an embodiment, each of the steps of method 300 may be a distinct step. In other embodiments, method 300 may not have all of the above steps and/or may have other steps in addition to or instead of those listed above. The steps of method 300 may be performed in another order. Subsets of the steps listed above as part of method 300 may be used to form their own method. In an embodiment, there could be multiple instances of method 300.

### Remote System-Side Method

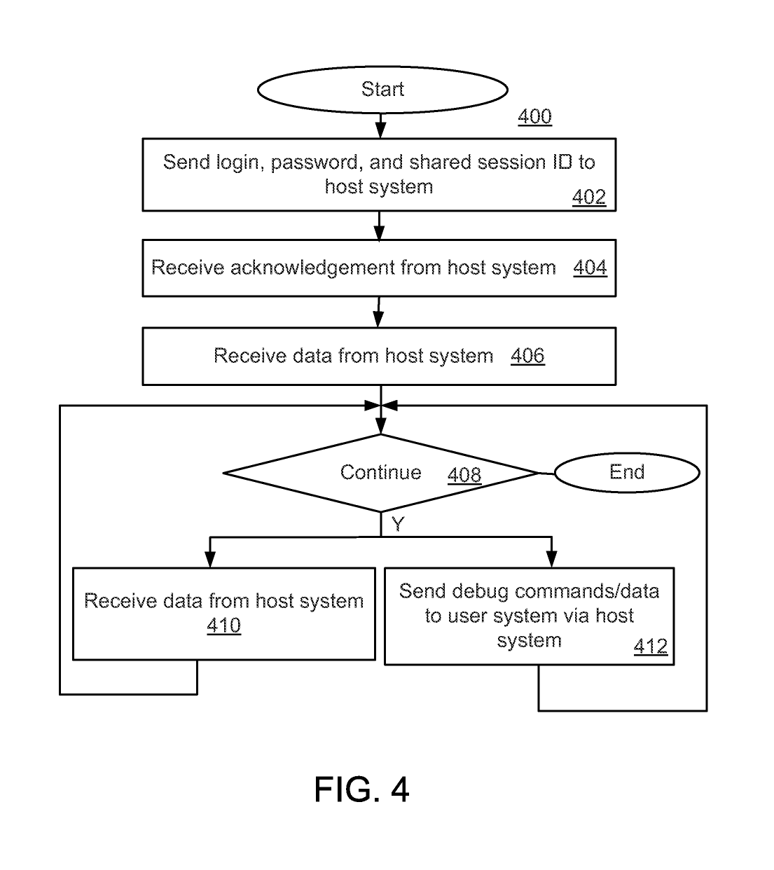

FIG. 4 shows a flowchart of an embodiment of a remote system-side method 400 of using a web-based system of providing access to a secure system from a remote system for debugging purposes.

In step 402, remote system 102 sends a login identifier, a password, and a shared session ID in order to login to host system and establish a shared session with secure system 120 at host 108. Optionally, as part of the login process, remote system 102 may receive a login session ID in addition to the shared session ID. Alternatively, the remote system 102 sends a shared session ID to host system 108 in order to login to host system and participate in a session with secure system 120, and the shared session ID may double as a login session ID. In step 404, remote system 102 receives acknowledgement from host system 108. In step 406, remote system 102 receives data from host system 108. The data may include display information from a HTTP enabled debugger running on a web browser on secure system 120. The data may include display information resulting from a software application 125 running on secure system 120. In step 408, method 400 waits for user input or from input from the host system. If the input indicates that the session is over, method 400 terminates. If remote system 102 receives or sends data from or to host system 108. Returning to step 408, if host system 108 sends data, method 400 proceeds to step 410, and remote system 102 receives more data from host system 108. Returning to step 408, if the user inputs a debug command or other data for secure system 108, method 400 proceeds to step 412, and in step 412, remote system 102 sends the debug commands and/or data to host system 108. The debug commands and/or data may be sent to secure system 120 so that HTTP enabled debugger 126 may apply the commands and/or data on the software application.

In an embodiment, each of the steps of method 400 may be a distinct step. In other embodiments, method 400 may not have all of the above steps and/or may have other steps in addition to or instead of those listed above. The steps of method 400 may be performed in another order. Subsets of the steps listed above as part of method 400 may be used to form their own method. In an embodiment, there could be multiple instances of method 400.

### System Overview

FIG. 5 illustrates a block diagram of an environment 510 wherein an on-demand database service might be used. Environment 510 may include user systems 512, network 514, system 516, processor system 517, application platform 518, network interface 520, tenant data storage 522, system data storage 524, program code 526, and process space 528. In other embodiments, environment 510 may not have all of the components listed and/or may have other elements instead of, or in addition to, those listed above.

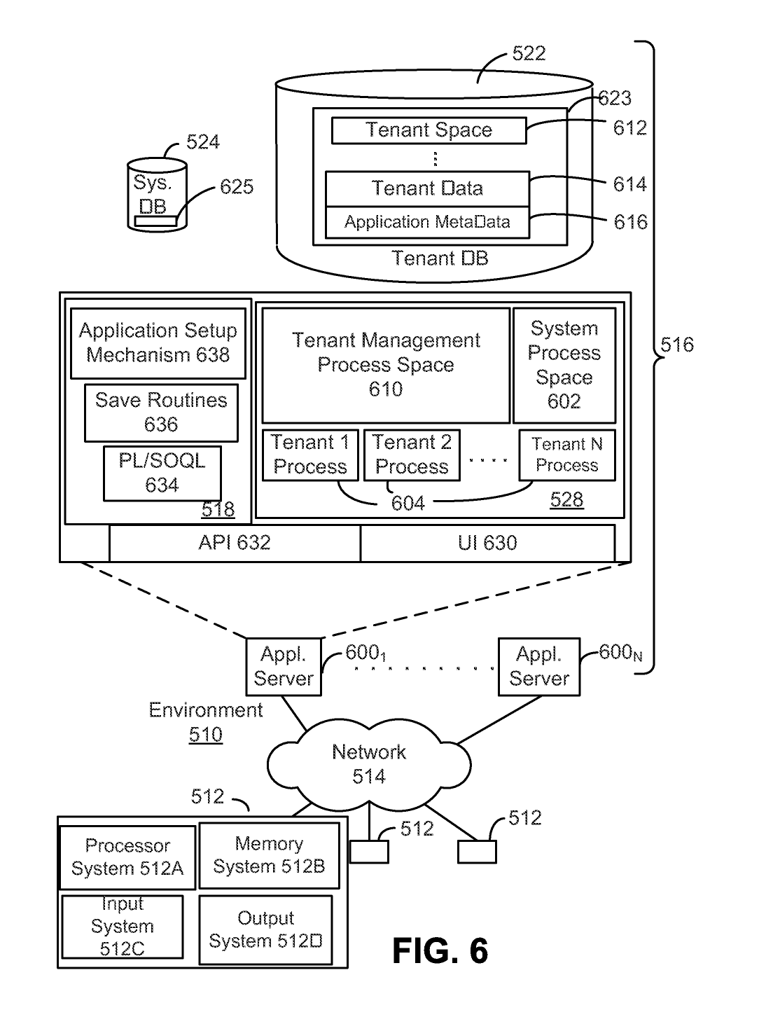

Environment 510 is an environment in which an on-demand database service exists. User system 512 may be any machine or system that is used by a user to access a database user system. For example, any of user systems 512 can be a handheld computing device, a mobile phone, a laptop computer, a work station, and/or a network of computing devices. As illustrated in FIG. 5 (and in more detail in FIG. 6) user systems 512 might interact via a network 514 with an on-demand database service, which is system 516. Remote system 102 and secure system 120 may be embodiments of user systems 512.

An on-demand database service, such as system 516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 516” and “system 516” will be used interchangeably herein. A database image may include one or more database objects. A relational database management system (RDMS) or the equivalent may execute storage and retrieval of information against the database object(s). Application platform 518 may be a framework that allows the applications of system 516 to run, such as the hardware and/or software, e.g., the operating system. In an embodiment, on-demand database service 516 may include an application platform 518 that enables creation, managing and executing one or more applications developed by the provider of the on-demand database service, users accessing the on-demand database service via user systems 512, or third party application developers accessing the on-demand database service via user systems 512.

The users of user systems 512 may differ in their respective capacities, and the capacity of a particular user system 512 might be entirely determined by permissions (permission levels) for the current user. For example, where a salesperson is using a particular user system 512 to interact with system 516, that user system has the capacities allotted to that salesperson. However, while an administrator is using that user system to interact with system 516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 514 is any network or combination of networks of devices that communicate with one another. For example, network 514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 512 might communicate with system 516 using TCP/IP and, at a higher network level, use other common Internet protocols to communicate, such as HTTP, FTP, AFS, WAP, etc. In an example where HTTP is used, user system 512 might include an HTTP client commonly referred to as a “browser” for sending and receiving HTTP messages to and from an HTTP server at system 516. Such an HTTP server might be implemented as the sole network interface between system 516 and network 514, but other techniques might be used as well or instead. In some implementations, the interface between system 516 and network 514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 516, shown in FIG. 5, implements a web-based customer relationship management (CRM) system. For example, in one embodiment, system 516 includes application servers configured to implement and execute CRM software applications as well as provide related data, code, forms, webpages and other information to and from user systems 512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 516 implements applications other than, or in addition to, a CRM application. For example, system 516 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 516.

One arrangement for elements of system 516 is shown in FIG. 5, including a network interface 520, application platform 518, tenant data storage 522 for tenant data 623, system data storage 524 for system data 625 accessible to system 516 and possibly multiple tenants, program code 526 for implementing various functions of system 516, and a process space 528 for executing MTS system processes and tenant-specific processes, such as running applications as part of an application hosting service. Additional processes that may execute on system 516 include database indexing processes.

Several elements in the system shown in FIG. 5 include conventional, well-known elements that are explained only briefly here. For example, each user system 512 could include a desktop personal computer, workstation, laptop, PDA, cell phone, or any wireless access protocol (WAP) enabled device or any other computing device capable of interfacing directly or indirectly to the Internet or other network connection. User system 512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 512 to access, process and view information, pages and applications available to it from system 516 over network 514. Each user system 512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 516 or other systems or servers. For example, the user interface device can be used to access data and applications hosted by system 516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 512 and all of its components are operator configurable using applications, such as a browser, including computer code run using a central processing unit such as an Intel Pentium® processor or the like. Similarly, system 516 (and additional instances of an MTS, where more than one is present) and all of their components might be operator configurable using application(s) including computer code to run using a central processing unit such as processor system 517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 6 also illustrates environment 510. However, in FIG. 6 elements of system 516 and various interconnections in an embodiment are further illustrated. FIG. 6 shows that user system 512 may include processor system 512A, memory system 512B, input system 512C, and output system 512D, and server1 118 and server2 128 may have the same structure as user 512 having a processor system, input system, output system and memory system. FIG. 5 shows network 514 and system 516. FIG. 6 also shows that system 516 may include tenant data storage 522, tenant data 623, system data storage 524, system data 625, User Interface (UI) 630, Application Program Interface (API) 632, PL/SOQL 634, save routines 636, application setup mechanism 638, applications servers 600₁-2700_{N}, system process space 502, tenant process spaces 504, tenant management process space 510, tenant storage area 512, user storage 514, and application metadata 516. In other embodiments, environment 510 may not have the same elements as those listed above and/or may have other elements instead of, or in addition to, those listed above.

User system 512, network 514, system 516, tenant data storage 522, and system data storage 524 were discussed above in FIG. 5. Regarding user system 512, processor system 512A may be any combination of one or more processors. Memory system 512B may be any combination of one or more memory devices, short term, and/or long term memory. Input system 512C may be any combination of input devices, such as one or more keyboards, mice, trackballs, scanners, cameras, and/or interfaces to networks. Output system 512D may be any combination of output devices, such as one or more monitors, printers, and/or interfaces to networks. As shown by FIG. 5, system 516 may include a network interface 520 (of FIG. 5) implemented as a set of HTTP application servers 600, an application platform 518, tenant data storage 522, and system data storage 524. Also shown is system process space 502, including individual tenant process spaces 504 and a tenant management process space 510. Each application server 600 may be configured to tenant data storage 522 and the tenant data 623 therein, and system data storage 524 and the system data 625 therein to serve requests of user systems 512. The tenant data 623 might be divided into individual tenant storage areas 512, which can be either a physical arrangement and/or a logical arrangement of data. Within each tenant storage area 512, user storage 514 and application metadata 516 might be similarly allocated for each user. For example, a copy of a user's most recently used (MRU) items might be stored to user storage 514. Similarly, a copy of MRU items for an entire organization that is a tenant might be stored to tenant storage area 512. A UI 630 provides a user interface and an API 632 provides an application programmer interface to system 516 resident processes to users and/or developers at user systems 512. The tenant data and the system data may be stored in various databases, such as one or more Oracle™ databases.

Application platform 518 includes an application setup mechanism 638 that supports application developers' creation and management of applications, which may be saved as metadata into tenant data storage 522 by save routines 636 for execution by subscribers as one or more tenant process spaces 504 managed by tenant management process 510 for example. Invocations to such applications may be coded using PL/SOQL 634 that provides a programming language style interface extension to API 632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 516 for the subscriber making the invocation and executing the metadata as an application in a virtual machine.

Each application server 600 may be communicably coupled to database systems, e.g., having access to system data 625 and tenant data 623, via a different network connection. For example, one application server 600₁ might be coupled via the network 514 (e.g., the Internet), another application server 600_{N-1} might be coupled via a direct network link, and another application server 600_{N} might be coupled by yet a different network connection. Transfer Control Protocol and Internet Protocol (TCP/IP) are typical protocols for communicating between application servers 600 and the database system. However, it will be apparent to one skilled in the art that other transport protocols may be used to optimize the system depending on the network interconnect used.

In certain embodiments, each application server 600 is configured to handle requests for any user associated with any organization that is a tenant. Because it is desirable to be able to add and remove application servers from the server pool at any time for any reason, there is preferably no server affinity for a user and/or organization to a specific application server 600. In one embodiment, therefore, an interface system implementing a load balancing function (e.g., an F5 Big-IP load balancer) is communicably coupled between the application servers 600 and the user systems 512 to distribute requests to the application servers 600. In one embodiment, the load balancer uses a least connections algorithm to route user requests to the application servers 600. Other examples of load balancing algorithms, such as round robin and observed response time, also can be used. For example, in certain embodiments, three consecutive requests from the same user could hit three different application servers 600, and three requests from different users could hit the same application server 600. In this manner, system 516 is multi-tenant, wherein system 516 handles storage of, and access to, different objects, data and applications across disparate users and organizations.

As an example of storage, one tenant might be a company that employs a sales force where each salesperson uses system 516 to manage their sales process. Thus, a user might maintain contact data, leads data, customer follow-up data, performance data, goals and progress data, etc., all applicable to that user's personal sales process (e.g., in tenant data storage 522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 516 might also maintain system level data usable by multiple tenants or other data. Such system level data might include industry reports, news, postings, and the like that are sharable among tenants.

In certain embodiments, user systems 512 (which may be client systems) communicate with application servers 600 to request and update system-level and tenant-level data from system 516 that may require sending one or more queries to tenant data storage 522 and/or system data storage 524. System 516 (e.g., an application server 600 in system 516) automatically generates one or more SQL statements (e.g., one or more SQL queries) that are designed to access the desired information. System data storage 524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 5 and 6)

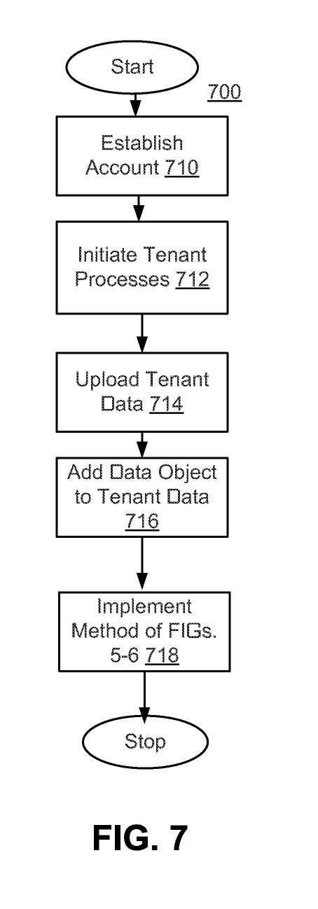

FIG. 7 shows a flowchart of an example of a method 700 of using environment 510. In step 710, user system 512 (FIGS. 5 and 6) establishes an account. In step 712, one or more tenant process space 604 (FIG. 6) are initiated on behalf of user system 512, which may also involve setting aside space in tenant space 612 (FIG. 6) and tenant data 614 (FIG. 6) for user system 512. Step 712 may also involve modifying application metadata to accommodate user system 512. In step 714, user system 512 uploads data. In step 716, one or more data objects are added to tenant data 614 where the data uploaded is stored. In step 718, the methods associated with FIGS. 5-6 may be implemented. In another embodiment, although depicted as distinct steps in FIG. 7, steps 702-718 may not be distinct steps. In other embodiments, method 700 may not have all of the above steps and/or may have other steps in addition to, or instead of, those listed above. The steps of method 700 may be performed in another order. Subsets of the steps listed above as part of method 700 may be used to form their own method.

### Method for Creating the Environment (FIGS. 5 and 6)

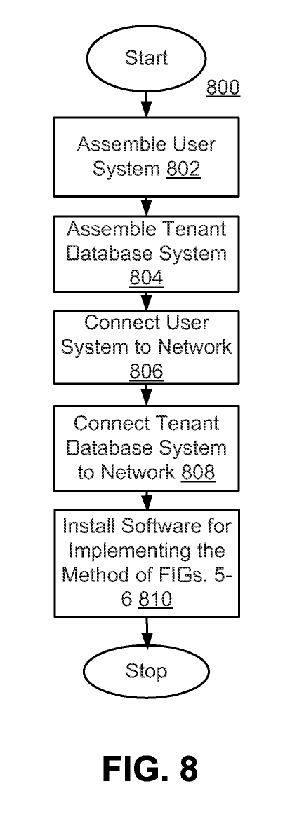

FIG. 8 is a method of making environment 510, in step 802, user system 512 (FIGS. 5 and 6) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 804, system 516 (FIGS. 5 and 6) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 516 may include installing application platform 518, network interface 520, tenant data storage 522, system data storage 524, system data 625, program code 526, process space 528, UI 630, API 632, PL/SOQL 634, save routine 636, application setup mechanism 638, applications servers 100₁-100_{N}, system process space 102, tenant process spaces 604, tenant management process space 110, tenant space 612, tenant data 614, and application metadata 116 (FIG. 6).

In step 806, user system 512 is communicatively coupled to network 604. In step 808, system 516 is communicatively coupled to network 604 allowing user system 512 and system 516 to communicate with one another (FIG. 6). In step 810, one or more instructions may be installed in system 516 (e.g., the instructions may be installed on one or more machine readable media, such as computer readable media, therein) and/or system 516 is otherwise configured for performing the steps of methods associated with FIGS. 5-6. In an embodiment, each of the steps of method 800 is a distinct step. In another embodiment, although depicted as distinct steps in FIG. 8, steps 802-810 may not be distinct steps. In other embodiments, method 800 may not have all of the above steps and/or may have other steps in addition to, or instead of, those listed above. The steps of method 800 may be performed in another order. Subsets of the steps listed above as part of method 800 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

While one or more implementations have been described by way of example and in terms of the specific embodiments, it may be to be understood that one or more implementations are not limited to the disclosed embodiments. To the contrary, it may be intended to cover various modifications and similar arrangements as would be apparent to those skilled in the art. Therefore, the scope of the appended claims may be accorded the broadest interpretation so as to encompass all such modifications and similar arrangements.

### Extensions and Alternatives

When there are bugs in an application installed and / or deployed on a computing device (e.g., the computer of a customer of an application provider) and the bug is not reproducible on the computing device of the application provider, it may be very difficult to debug and solve the issue. Companies making use of an application, such banks and healthcare facilities, may not allow remote login access to their computers, or direct remote control of their computing devices, due to security and other concerns. It is often necessary to go through multiple iterations of debug binaries and log files in order to troubleshoot and/or debug applications, and if the issue is not solved within a pre-established time period, it may be necessary for the application provider to send a person to the customer site (i.e., the physical location of the computing device running the application that needs to be debugged) to debug the issue.

Sending a person to a physical location takes lot of time and effort, and is required because developers are unable to debug the issue from their desks. If companies allow developers to login to remotely, then a developer can solve the problem very easily.

In an embodiment, a debugging tool is installed on the customer computing device, and the debugging tool facilitates the debugging of an application (present on the customer computing device) from the physical location of the developer (i.e., programmers or software technicians), via HTTP. HTTP communications are allowed on servers and most computing devices (in comparison to direct login access to the device, which is usually disallowed, which would make remote debugging impossible). In an embodiment, an HTTP enabled debugger (such as http GDB for C/C++ on UNIX, HTTP Java debugger etc), may be used for debugging issues on the customer computing device, as follows. The use of the HTTP enabled debugger (on the customer computing device) allows a remote HTTP client (such as the web browser on the developer's computer, or a plug-in to the developer's web browser) to communicate with the HTTP enabled debugger on the customer computing device.

In an embodiment, the remote HTTP client may communicate with the HTTP enabled debugger through an intermediary server (such as a web server for managing debugging sessions and relaying information necessary for debugging, such as debugging commands and instructions, debugging results, and information about the environment of the application being debugged). The developer may then debug the issue remotely, through a web browser, while sitting at the developer's own desk, for example, without the need to login directly to the computing device of the customer. In an embodiment, the remote HTTP client may communicate with the HTTP enabled debugger directly.

In an embodiment, an applet is downloaded and installed to the customer computing device. The applet downloads and installs the HTTP debugger to the customer computing device and the applet attaches the HTTP debugger to the targeted process (e.g., the applet provides the HTTP debugger with information about the application and/or specific code to be debugged). In an alternative embodiment, the HTTP enabled debugger is downloaded and installed directly to the customer computing device.

In an embodiment, the HTTP debugger communicates directly with the intermediary server and the intermediary server relays what is communicated to the HTTP client of the developer (i.e., the developer's browser). In an embodiment, there is debugging interface (i.e., a web page) the developer accesses via the developer's web browser. The developer enters debugging commands via the interface, and the debugging commands are sent to the intermediary server via the developer's web browser. The intermediary server receives the debugging commands from the developer's web browser and relays the commands to the HTTP debugger on the customer's computing device.

Although the invention has been described with reference to specific embodiments, it may be understood by those skilled in the art that various changes may be made and equivalents may be substituted for elements thereof without departing from the true spirit and scope of the invention. In addition, modifications may be made without departing from the essential teachings of the invention.

1. A method of enabling access to data on a secure system from a remote system comprising:
granting access and allowing a connection to be established to the secure system, by a host system, the host system including at least a processor system having at least one processor and a memory system having one or more computer readable media;
granting access and allowing a connection to be established to the remote system, by the host system, the remote system not being authorized to directly access the secure system;
receiving at the host system, at least one debug command from the remote system; and
sending the at least one debug command from the host system to the secure system, therein the host facilitating the remote system to run a debugger on the secure system despite the secure system not granting direct access to the remote system.

2. The method of claim 1, further comprising:
receiving at the host system, display information from the secure system, via a Hyper Text Transport Protocol (HTTP) enabled debugger running on a web browser, about a problem resulting from an application running on the secure system; and
sending by the host system, the display information to the remote system.

3. The method of claim 2, further comprising running the at least one debug command on the HTTP enabled debugger running on the secure system.

4. The method of claim 1, the application running on the secure system causing the secure system to interact with a multi-tenant database system.

5. The method of claim 1, the granting of the access and the allowing of the connection to be established to the secure system by the host system requires a session ID.

6. The method of claim 1, the granting of the access and the allowing of the connection to be established to the remote system by the host system requires a session ID.

7. The method of claim 1 further comprising requiring a session ID common to the host system and the secure system to establish a session by the host system with the secure system and the remote system.

8. The method of claim 7, generating the session ID at the host system in response to a request prior to establishing the session.

9. The method of claim 1, further comprising running a Java applet on the web browser of the secure system to download and start the HTTP enabled debugger.

10. A method comprising:
sending a request from a first system to establish a session with a second system on a host system, the first system having a processor system including at least a processor and a memory system including at least a machine readable medium;
receiving at the first system, via the host system, results of running an application on the second system;
sending a debug command from the first system, by the processor system of the first system, via the host system to the second system;
receiving at the first system, via the host system, results of running the debug command on the second system; and
therein the remote system controlling a debugger on the secure system despite the secure system not granting direct access to the remote system.

11. The method of claim 10, the sending a request from the first system to establish a session with the second system on the host system requires a session ID common to the first system and the second system.

12. A method comprising:
sending a request from a secure system to establish a session on a host system, the session being with a remote system, the remote system having a processor system including at least one processor and a memory system including at least a machine readable medium;
receiving at the secure system, via the host system, a debug command from a remote system;
running the debug command, via a web enabled debugger, on the secure system;
sending results of running the debug command from the secure system to the remote system; and
therein the enabling the remote system to run a HTTP enabled debugger on the secure system despite the secure system not granting direct access to the remote system.

13. The method of claim 12, the sending a request from a secure system to establish a session with the remote system on a host system requires a session ID common to the secure system and the remote system.
